(19) United States
(12) Patent Application Publication
(10) Pub. No.: US 2026/0185825 A1
(43) Pub. Date: Jul. 2, 2026

(54) Methods And Systems For Mapping Surface Topography Of Semiconductor Substrates

(71) Applicant: KLA Corporation, Milpitas, CA (US)

(72) Inventors: Mark Kooy, Chandler, AZ (US); Charles A. Monjak, Dedham, MA (US)

(21) Appl. No.: 19/002,180

(22) Filed: Dec. 26, 2024

(51) Int. Cl. G01B 11/24; G01B 7/06; G01N 21/88; G01N 21/95

(52) U.S. Cl. CPC G01B 11/24; G01N 21/8806; G01N 21/9501; G01B 7/082; G01N 2021/8848

(57) ABSTRACT

Methods and systems for high throughput and high resolution measurement of surface topography of substrates employed in semiconductor device manufacturing are described herein. A beam steering device scans an illumination beam along a beam scan path incident on a substrate surface. In addition, a specimen positioning system moves the substrate with respect to the illumination beam. In some embodiments, a hypercentric focusing lens in the illumination beam path between the beam steering device and the substrate eliminates the need for an optical element in the optical path between the surface under measurement and a position sensitive detector in the optical path of the reflected beam. A computing system generates a map of wafer tilt based on the detected position of the reflected beam at the detector. In a further aspect, a high resolution surface height map is generated based on the measured surface tilt map.

### TECHNICAL FIELD

The described embodiments relate to systems for surface inspection, and more particularly to semiconductor wafer inspection modalities.

### BACKGROUND INFORMATION

Semiconductor devices such as logic and memory devices are typically fabricated by a sequence of processing steps applied to a substrate or wafer. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Semiconductor design rules continue to evolve to continue to shrink device dimensions, and thus increase computing performance with reduced product cost. In one example, the line width of conductors fabricated on the surface of a silicon wafer has been steadily reduced at each fabrication process node. Line widths as small as a few nanometers are currently employed in semiconductor fabrication facilities. The optics required to perform various lithographic processing steps at nanometer scale line widths are severely limited in depth of focus. As a result, lithographic processing is very sensitive to substrate surface undulations.

In general, the surface topology of bare semiconductor wafers must meet stringent specifications to ensure sufficient process yield. Furthermore, in some examples, the surface topology of bare semiconductor wafers must be accurately characterized to provide input data to processing tools to compensate for known surface topology. In some examples, it is desirable to map the height of the surface of a wafer with a resolution one nanometer or less, with an in-plane spatial resolution of 200 micrometers, or less.

In general, it is desirable to measure the topography of surfaces in a broad range of application settings. Mechanical measurement techniques are often employed, but mechanically based topographic measurements are limited in measurement sensitivity. In particular, the measurement of a highly polished surface with nanometer scale resolution is not achievable by mechanical measurement systems due to surface damage and lack of measurement sensitivity.

Measurement of surface topography by non-contact measurement techniques avoids the risks of mechanical contact. However, it is difficult to achieve the required measurement resolution and measurement throughput using existing systems. In some examples, inductive or capacitive probes may be employed to measure surface height at high resolution in the height direction. Unfortunately, these sensors are not capable of high in-plane spatial resolution due to the relatively large surface area probed by the inductive or capacitive instrument.

An optically based topography measurement system is described in U.S. Pat. No. 6,621,581, the content of which is incorporated herein by reference in its entirety. The optically based system employs a scanning mirror, combined with curved reflectors, to generate a scan line that spans the entire wafer in one direction. To scan the entire wafer surface, the wafer is mechanically moved in a direction perpendicular to the scan line. As such, the surface of the entire wafer is scanned by moving the wafer in one direction. Such a system is not scalable to larger wafer sizes, requires in-situ calibration using external components such as moving/tilting mirrors, etc., and is physically incompatible with other wafer inspection or metrology processes. As a result, the described topographic measurement system requires an independent footprint within the semiconductor fabrication facility, which adds undesirable cost to the fabrication process.

As semiconductor design rules continue to evolve, the surface topography of semiconductor substrates must be characterized with nanometer resolution in height and high in-plane spatial resolution, in addition to characterization of local surface tilt. Current optically based surface topography measurement systems are limited in measurement resolution and throughput. Improvements to optically based surface topography measurement systems are desired to characterize semiconductor substrates with greater sensitivity, resolution, and throughput.

### SUMMARY

High throughput and high resolution measurement of surface topography of substrates employed in semiconductor device manufacturing is achieved using optically based, non-destructive measurement systems and techniques. The methods and systems for characterizing substrate surface topography presented herein employ two-dimensional scanning of the substrate under measurement to expose the entire substrate surface to measurement at high resolution and high throughput.

In some embodiments, a surface topography measurement system as described herein is integrated with a scanning type semiconductor fabrication tool that performs other measurement or inspection functions, an optical inspection tool, a defect review tool, an integrated optical inspection/defect review tool, etc. In this manner throughput is increased by characterizing surface topology across the substrate surface while additional metrology or inspection functions are performed on the same substrate.

In one aspect, a surface topography measurement subsystem includes a beam steering device in the path of the illumination beam propagating from the illumination source to the substrate surface under measurement. The beam steering device scans the illumination beam along a beam scan path incident on the substrate surface.

In another aspect, the dimensions of the beam scan path traced out by the beam steering device at incidence with the substrate are less than the dimensions of the substrate under measurement. Thus, to measure any desired location on the surface of the substrate, the substrate is moved relative to the illumination beam.

In another aspect, a surface topology measurement subsystem employs an acousto-optical deflector (AOD) as a beam steering device. It is advantageous to employ an AOD as a beam steering device due to its static construction. There are no moving mechanical elements in mechanical contact. Thus, there is a reduced risk of mechanical failure due to wear or fatigue, and reduced risk of particle generation which may lead to particle contamination of the surface of the specimen under measurement. Although an AOD is a preferred beam steering device employed in a surface topography measurement subsystem, in general, any other suitable beam steering device may be contemplated within the scope of this patent document.

In another aspect, a surface topography measurement subsystem employs a hypercentric focusing optical element in the illumination beam path between the beam steering device and the surface of the specimen.

In another aspect, a surface topography measurement subsystem includes a position sensitive detector (PSD) positioned to detect the reflected beam. The PSD includes an active surface sensitive to the position of the detected reflected beam.

The hypercentric focusing optical element eliminates the need for an optical element in the optical path between the surface under measurement and the position sensitive detector. In this manner, light reflected from the surface under measurement propagates to the detector and is incident on the detector at the desired spot size without passing through any intervening optical elements. This approach, in combination with an off-axis illumination design, is advantageous because it eliminates the likelihood that particles settle on optical surfaces in the collection path and contaminate the optical signal received on the detector.

In another aspect, a surface topography measurement system includes a computing system configured to generate a map of wafer locations and corresponding wafer tilt in two dimensions.

In a further aspect, for each measurement instance, the computing system determines the location of incidence of the illumination beam on the surface of a substrate in terms of substrate coordinates based on the substrate position and the beam pointing orientation. Furthermore, for each measurement instance, the computing system associates the surface tilt with the location of incidence. A map of wafer tilt expressed in terms of wafer locations is generated by aggregating the results of many measurement instances generated over the surface of a substrate.

In a further aspect, a computing system is configured to generate a high resolution surface height map based on the measured surface tilt map. The high resolution surface height map has high resolution in the direction normal to the surface of the wafer, e.g., sub-nanometer height resolution, with a high spatial resolution in the in-plane directions, e.g., the X-Y directions.

In a further aspect, a surface topology measurement system is configured to identify regions of a substrate having variation in surface height, surface tilt, or both, that exceed predetermined threshold values. These regions are highlighted as possible defect regions that require subsequent cleaning, rework, disposal, etc.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified schematic view of one embodiment of a substrate surface topography measurement system with surface characterization functionality as described herein.

FIG. 2 is a simplified diagram illustrative of a top view of a wafer undergoing measurement by a substrate surface topography measurement system with surface characterization functionality as described herein.

FIG. 3 is a simplified diagram illustrative of a view of a quadrant photodiode from the perspective of an incoming beam.

FIG. 4 is a simplified schematic view of another embodiment of a substrate surface topography measurement system with surface characterization functionality as described herein.

FIG. 5 is a diagram illustrative of the map locations of an exemplary low resolution height map and an exemplary high resolution height map generated by integration of a tilt map generated by a surface topography measurement subsystem.

FIG. 6 is a diagram illustrative of a flowchart of an exemplary method useful for characterizing surface topology.

### DETAILED DESCRIPTION

Reference will now be made in detail to background examples and some embodiments of the invention, examples of which are illustrated in the accompanying drawings.

Methods and systems for high throughput and high resolution characterization of surface topography of substrates employed in semiconductor device manufacturing are described herein. In some embodiments, nanometer scale variations in surface tilt and height are measured in accordance with the methods and systems described herein. The methods and systems for characterizing substrate surface topography presented herein are optically based and non-destructive.

Moreover, the methods and systems for characterizing substrate surface topography presented herein employ two-dimensional scanning of the substrate under measurement to expose the entire substrate surface to measurement at high resolution and high throughput. In some embodiments, a surface topography measurement system as described herein is integrated with a scanning type semiconductor fabrication tool that performs other measurement or inspection functions, an optical inspection tool, a defect review tool, an integrated optical inspection/defect review tool, etc. In this manner throughput is increased by characterizing surface topology across the substrate surface while additional metrology or inspection functions are performed on the same substrate, e.g., defect inspection, defect review, etc. In these embodiments, existing optical inspection and optical review tools are enhanced by incorporating the systems and methods described herein.

By integrating a surface topography measurement system as described herein with a scanning type semiconductor fabrication tool, high resolution, high throughput characterization of surface topography is enabled for substrates of any size or shape employed as part of the semiconductor manufacturing process flow.

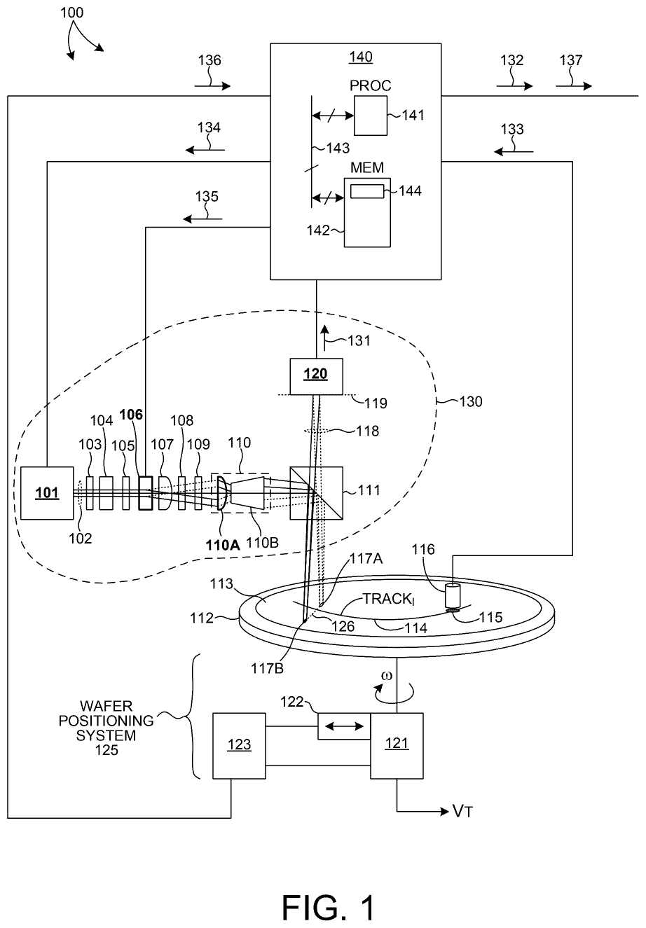

FIG. 1 is a simplified schematic view of one embodiment of a substrate surface topography measurement system 100 with surface characterization functionality as described herein. As depicted in FIG. 1, surface topography measurement subsystem 130 is integrated as part of surface topography measurement system 100. Surface topography measurement system 100 is provided by way of non-limiting example. In general, a surface topography measurement subsystem may be implemented as part of a bench-top analytical tool, as part of an automated system for defect inspection, defect review, or both, etc.

For simplification, some optical components of the system have been omitted. By way of example, folding mirrors, polarizers, beam forming optics, additional light sources, additional collectors, and additional detectors may also be included. All such variations are within the scope of the invention described herein. The surface topography measurement systems described herein may be used for inspecting unpatterned, as well as patterned substrates, including, but not limited to wafers employed in the semiconductor industry.

As illustrated in FIG. 1, surface topography measurement subsystem 130 includes an illumination source 101 that generates a beam of illumination light 102 directed toward wafer 113. In preferred embodiments, illumination source 101 is a laser based illumination source, including, but not limited to, a diode laser, a helium neon laser, an argon laser, a solid state laser, a diode pumped solid state (DPSS) laser, etc.

In the embodiment depicted in FIG. 1, spatial filter 103 and collimating optics 104 shape the illumination beam 102 directed toward wafer 113. In preferred embodiments, the output beam of a low-noise laser is shaped into a highly collimated beam with a Gaussian intensity profile.

In other embodiments, illumination source 101 is a broadband illumination source, including, but not limited to a xenon arc lamp, a gas discharging lamp, an LED array, an incandescent lamp, etc. In some embodiments, the illumination subsystem is configured to direct light having a relatively narrow wavelength band to the specimen (e.g., nearly monochromatic light or light having a wavelength range of less than about 20 nm, less than about 10 nm, less than about 5 nm, or even less than about 2 nm) for an interval of time. Therefore, if the light source is a broadband light source, the illumination subsystem may also include one or more spectral filters that may limit the wavelength of the light directed to the specimen. The one or more spectral filters may be bandpass filters and/or edge filters and/or notch filters.

In some examples, the wavelengths of light incident on wafer 113 include any subset of wavelengths ranging from infrared to extreme ultraviolet. In general, illumination source 101 emits radiation at any desired wavelength or range of wavelengths of light within the optical wavelength range.

In the embodiment depicted in FIG. 1, illumination source 101 is configured to control the optical power of the beam of illumination light 102 in accordance with command signal 134 received from computing system 140. In one embodiment, illumination source 101 dynamically adjusts the illumination power during a surface scan to ensure adequate signal to noise ratio at the detector 120.

In one aspect, a surface topography measurement subsystem includes a beam steering device in the path of the illumination beam propagating from the illumination source to the substrate surface under measurement. The beam steering device scans the illumination beam along a beam scan path incident on the substrate surface.

As depicted in FIG. 1, surface topography measurement subsystem 130 includes beam steering device 106 in the optical path between illumination source 101 and wafer 113. Beam steering device 106 introduces a continuous change in beam pointing of illumination beam 102 at beam steering device 106 that results in repeated scanning of illumination beam 102 at incidence with wafer 113. As depicted in FIG. 1, beam steering device 106 causes the area of incidence of illumination beam 102 with wafer 113, i.e., measurement spot 117, to oscillate, back and forth, along beam scan path 126 between measurement spots 117A and 117B. In a preferred embodiment, beam scan path 126 is a one-dimensional path, i.e., a line. However, in general, any repeated path may be contemplated within the scope of this patent document, e.g., elliptical, circular, wavy line, etc.

In one example, beam steering device 106 operates at a scan rate of at least 10 kilohertz, scanning across a beam scan path of length 2.5 millimeters in approximately 50 microseconds, with an illumination spot size of approximately 200 micrometers. At a sampling rate of 1 megahertz, i.e., measurement instances are separated by 1 microsecond, measurement spot 117 moves across the surface of wafer 113 approximately 50 micrometers between each measurement instance. Thus, any point on the surface of wafer 113 is sampled more than two times, e.g., three or four times, thus ensuring aliasing effects are minimized. In general, any suitable scan rate, beam scan path length, measurement spot size, and sampling rate may be selected to ensure the entire surface of a wafer is measured at the required wafer measurement throughput without aliasing.

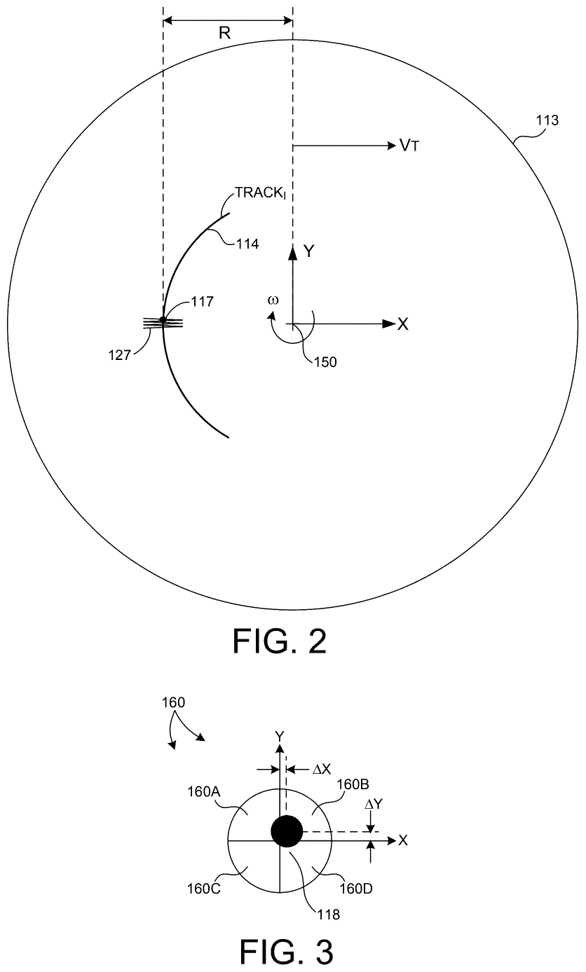

In another aspect, the dimensions of the beam scan path traced out by the beam steering device at incidence with the substrate are less than the dimensions of the substrate under measurement. In one example, the length of beam scan path 126 is on the order of a few millimeters, e.g., 1-3 millimeters, but wafer 113 has dimensions in the plane of the surface under measurement of hundreds of millimeters. In one example, depicted in FIG. 2, wafer 113 extends 300 millimeters in two orthogonal directions, i.e., the X and Y directions. Thus, to measure any desired location on the surface of the substrate, the substrate must be moved relative to the illumination beam 102 such that the area of incidence of illumination beam 102 includes any desired location on the surface of wafer 113.

In the embodiment illustrated in FIG. 1, wafer positioning system 125 moves wafer 113 with respect to illumination beam 102. Wafer positioning system 125 includes a wafer chuck 112, motion controller 123, a rotation stage 121 and a translation stage 122. Wafer 113 is supported on wafer chuck 112. As illustrated in FIG. 2, wafer 113 is located with its geometric center 150 approximately aligned the axis of rotation of rotation stage 121. In this manner, rotation stage 121 spins wafer 113 about its geometric center at a specified angular velocity, ω, within an acceptable tolerance. In addition, translation stage 122 translates the wafer 113 in a direction approximately perpendicular to the axis of rotation of rotation stage 121 at a specified velocity, V_{T}. Motion controller 123 coordinates the spinning of wafer 113 by rotation stage 121 and the translation of wafer 113 by translation stage 122 to achieve the desired scanning motion of wafer 113 within system 100.

In an exemplary operational scenario, surface topology measurement begins with measurement spot 117 located at the geometric center 150 of wafer 113 and then wafer 113 is rotated and translated until measurement spot 117 reaches the outer perimeter of wafer 113 (i.e., when R equals the radius of wafer 113). Due to the coordinated motion of rotation stage 121 and translation stage 122, wafer 113 is positioned with respect to illumination beam 102 at a fixed beam pointing orientation along a spiral path on the surface of wafer 113. The spiral path on the surface of wafer 113 is referred to as a wafer scan track 114 (not shown in its entirety). A portion of an exemplary wafer scan track 114 is illustrated in FIG. 2 as TRACKᵢ.

Simultaneously, beam steering device 106 continuously oscillates illumination beam 102 along the beam scan path at incidence with wafer 113. In the embodiment depicted in FIGS. 1 and 2, beam scan path 126 is a linear path oriented approximately perpendicular to wafer scan track 114. As a result of the combined motion of wafer 113 and beam pointing of illumination beam 102, the locus of points illuminated by measurement spot 117 traces an oscillating path approximately perpendicular to the wafer scan track. A portion 127 of the locus of points illuminated by measurement spot 117 is illustrated in FIG. 2. In this manner, the entire surface of wafer 113 is subject to exposure to measurement spot 117.

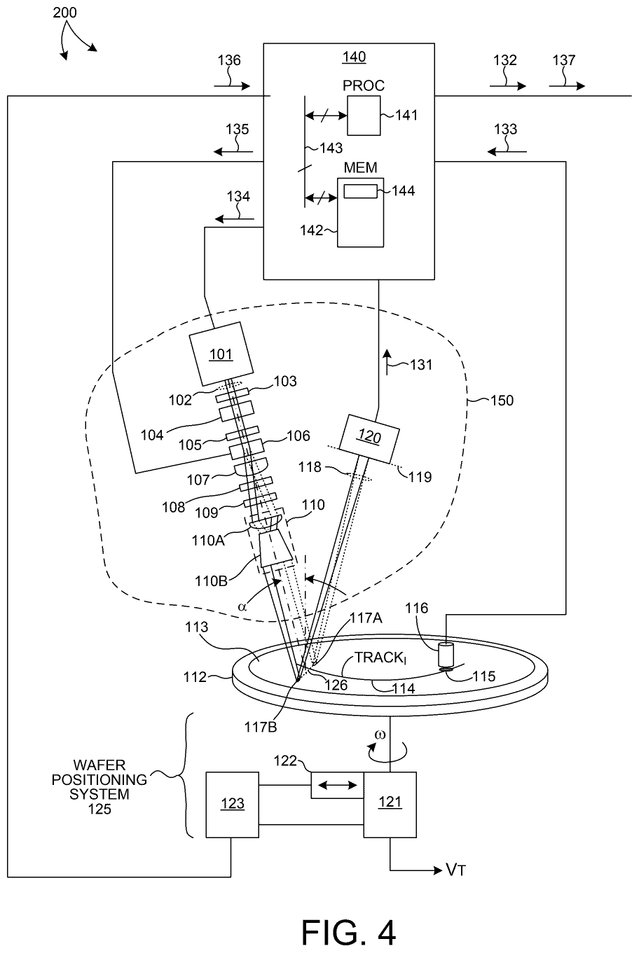

In the embodiments depicted in FIGS. 1 and 4, wafer positioning system 125 employs a rotary stage architecture. However, in general, any suitable motion stage architecture capable of positioning the entire surface of the specimen under measurement in the path of illumination beam 102 is contemplated within the scope of this patent document. By way of non-limiting example, wafer positioning system 125 may employ a wafer stage with two linear, long stroke axes oriented perpendicular to one another, a.k.a., an XY stage, to position wafer 113. In these examples, the wafer scan track is a sequence of passes across the wafer, e.g., in the X-direction, separated by a sequence of steps in the orthogonal direction, e.g., in the Y-direction.

In the embodiments depicted in FIGS. 1 and 4, the beam scan path is oriented approximately perpendicular to the wafer scan track. However, in general, the beam scan path may be oriented in any suitable direction with respect to the wafer scan track.

In another aspect, a surface topology measurement subsystem employs an acousto-optical deflector (AOD) as the beam steering device. In the embodiments depicted in FIGS. 1 and 4, beam steering device 106 is an AOD. It is advantageous to employ an AOD as a beam steering device due to its static construction. There are no moving mechanical elements in mechanical contact. Thus, there is a reduced risk of mechanical failure due to wear or fatigue, and reduced risk of particle generation which may lead to particle contamination of the surface of the specimen under measurement. Particle contamination of the specimen under measurement is an ever present issue in a semiconductor fabrication facility, and minimizing the sources of possible contamination is highly valued in a semiconductor manufacturing setting.

Although an AOD is a preferred beam steering device employed in a surface topography measurement subsystem, in general, any other suitable beam steering device may be contemplated within the scope of this patent document. In some embodiments, a micromirror device may be employed as a beam steering device. In other embodiments, a macroscopic mirror mounted to a high-speed actuator in a non-resonant or resonant mounting configuration may be employed as a beam steering device. Exemplary high speed actuators include piezoelectric or magnetostrictive actuators. In other embodiments, a rotating mirror assembly having one or more mirror faces may be employed as a beam steering device. In these embodiments, the rotational velocity of the mirror assembly is selected as an integer fraction of the required beam scanning rate.

In the embodiments depicted in FIGS. 1 and 4, linear polarizer element 105 is employed to polarize illumination beam 102 before entry into AOD 106. In this manner, AOD 106 steers the entire illumination beam 102. In addition, cylindrical lens 107 and linear polarizer 108 are employed to condition illumination beam 102 after exit from AOD 106. AODs introduce a small amount of angular distortion, a.k.a., “chirp”, and a small amount of polarization dispersion into the output beam. Cylindrical lens 107 is selected with opposite power and the same focal length of the AOD to counteract the angular distortion introduced by the AOD. Linear polarizer 108 is employed to polarize illumination beam 102 after exit from AOD 106.

In embodiments where a mirror based beam steering device is employed, rather than an AOD, cylindrical lens 107 and linear polarizer 108 may not be employed.

In another aspect, surface topography measurement subsystem employs a hypercentric focusing optical element in the illumination beam path between the beam steering device and the surface of the specimen.

As depicted in FIGS. 1 and 4, the hypercentric focusing optical element 110A enables illumination beam 102 to be scanned across the beam scan path 126 without movement across the active surface 119 of position sensitive detector (PSD) 120, if the surface of wafer 113 is perfectly flat across the beam scan path. In other words, the position of incidence of the reflected beam 118 on the active surface 119 of PSD 120 depends on tilt at the surface of wafer 113 within measurement spot 117 and is independent of the beam pointing orientation of illumination beam 102.

In the embodiment depicted in FIG. 1, the hypercentric focusing optical element is a lens element 110A having optical surfaces shaped to focus illumination beam 102 onto measurement spot 117 on wafer 113, i.e., the nominal focal plane of lens element 110A is approximately aligned with the surface of wafer 113. In some examples, lens 110A is an asphere. In some other examples, lens 110A is a spherical lens having both optical surfaces, i.e., the beam entrance and exit surfaces, fabricated to a different curvature. In addition, as depicted in FIG. 1, beam expansion lens 110B is employed in the illumination beam path after lens 110A as part of a hypercentric optical assembly 110. Beam expansion lens 110B is optional, but is advantageous as it allows the hypercentric design to be implemented with optical path lengths that meet practical dimensional constraints on the optical path length of the surface topography measurement subsystem. Moreover, beam expansion lens 110B maintains the hypercentric focusing capability of hypercentric focusing lens 110A over a larger range of beam pointing orientations. In other words, for a given path length of illumination beam 102, beam expansion lens 110B enables illumination beam 102 to be scanned across a larger range of beam pointing orientations, i.e., a longer beam scan path 126, without movement across the active surface 119 of position sensitive detector (PSD) 120 when the surface of wafer 113 is perfectly flat across the beam scan path 126.

In another aspect, a surface topography measurement subsystem includes a position sensitive detector (PSD) positioned to detect the reflected beam. The PSD includes an active surface sensitive to the position of the detected reflected beam. In the embodiment depicted in FIG. 1, PSD 120 includes an active surface 119 sensitive to the position of the detected reflected beam 118. In some embodiments, PSD 120 is a quadrant photodetector, e.g., quadrant photodiode, that generates quadrature signals indicative of the position of the incoming beam based on measured beam power within each quadrant.

FIG. 3 is a simplified diagram illustrative of a view of a quadrant photodiode 160 suitable for use as PSD 120 from the perspective of an incoming beam, e.g., reflected beam 118. Quadrant photodiode 160 includes four photodiodes 160A-D arranged in quadrants. Each of the four photodiodes 160A-D produces its own electrical signal as a function of the intensity of light detected by the photodiode. Accordingly, the relative magnitude of the four signals indicates the amount the incident beam is off-center, and thus the position of the incident beam at the active surface of the detector.

In one embodiment quadrant photodiode 160 is positioned to detect reflected beam 118 on the active surface of the quadrant photodiode 160. If illumination beam 102 is incident on the surface of wafer 113 at a location with zero slope, e.g., a zero reference slope, the surface topography measurement subsystem is calibrated such that reflected beam 118 is centered on the active surface of the quadrant photodiode 160 at the origin of the X-Y coordinate frame, i.e., at the point where the four quadrants meet in the middle of quadrant photodiode 160. In this scenario, each of the photodiodes 160A-D detects the same amount of light.

Similarly, if illumination beam 102 is incident of the surface of wafer 113 at a location with non-zero slope, e.g., a slope that is different from a zero reference slope, the reflected beam 118 is off-center on the active surface of the quadrant photodiode 160. As depicted in FIG. 3, reflected beam 118 is off-center in both the X and Y directions by the amounts ΔX and ΔY, respectively. In this scenario, each of the photodiodes 160A-D detect different amounts of light. Equations (1) and (2) express the position of reflected beam 118 in terms of photodiode signals, where A, B, C, and D, are the signal strengths of photodiodes 160A, 160B, 160C, and 160D, respectively, and k is a calibration constant to convert signal strength, e.g., in millivolts, to spot location with respect to the zero-slope spot location, e.g., micrometers.

$$Δ X = k [ ( A + C ) - ( B + D ) ] \qquad ( 1 )$$

$$Δ Y = k [ ( A + B ) - ( C + D ) ] \qquad ( 2 )$$

In addition, the spot location at the active surface 119 of detector 120 is directly related to the surface slope. More particularly, where the hypercentric focusing optical element 110A in combination with beam expansion optic 110B has a focal length, f, the spot location is illustrated by equations (3) and (4), where Δθₓ and Δθ_{y} are the reflected angles with respect to zero slope in the X and Y directions, respectively.

$$Δ X = f ( Δ {θ}_{X} ) \qquad ( 3 )$$

$$Δ Y = f ( Δ {θ}_{Y} ) \qquad ( 4 )$$

The changes in reflected angles from zero slope are equal to twice the changes in the surface angles, which for very small surface angles closely approximate to twice the changes in the surface slopes, as illustrated by equations (5) and (6), where ΔTₓ and ΔT_{y} are the surface slope, i.e., tilt, with respect to zero surface slope in the X and Y directions, respectively.

$$Δ {T}_{X} = Δ {θ}_{X} / 2 = Δ X / ( 2 f ) \qquad ( 5 )$$

$$Δ {T}_{Y} = Δ {θ}_{Y} / 2 = Δ Y / ( 2 f ) \qquad ( 6 )$$

Furthermore, as illustrated in equations (5) and (6), ΔTₓ and ΔT_{y} are expressed in terms of the position of the reflected beam measured by PSD 120, ΔX and ΔY, based on equations (3) and (4), respectively. In this manner, the changes in surface slopes in two dimensions from zero reference slopes in both dimensions are readily determined from the measured location of incidence of reflected beam 118 on PSD 120, which are, in turn, directly determined from signals 131 generated by PSD 120.

As depicted in FIG. 1, illumination beam 102 is directed to wafer 113 by reflection from beam splitter 111. Reflected beam 118 passes through beam splitter 111 to PSD 120. In this embodiment, illumination beam 102 is incident on wafer 113 at an angle of incidence that is normal to a plane parallel with the surface of wafer 113 under measurement. To achieve normal incidence, beam splitter 111 is located in the optical path of reflected beam 118. In general, it may be undesirable to locate optical elements between the wafer surface and the detector as the optical elements need to remain extremely clean to avoid contamination of the optical signal.

In some other embodiments, a surface topography measurement subsystem is configured such that illumination beam 102 is incident on wafer 113 at an angle of incidence that is not normal to a plane parallel with the surface of wafer 113 under measurement.

FIG. 4 is a diagram illustrative of a surface topography measurement system 200 in another embodiment. Like numbered elements are analogous to those described with reference to FIG. 1. Surface topography measurement system 200 is similar to surface topography measurement system 100 depicted in FIG. 1. In the embodiment depicted in FIG. 4, beam splitter 111 is not employed and the optical elements are arranged to deliver illumination beam 102 at a non-zero angle of incidence, a, with respect to the surface normal of wafer 113.

The hypercentric focusing optical element eliminates the need for an optical element in the optical path between the surface under measurement and the position sensitive detector. In this manner, light reflected from the surface under measurement propagates to the detector and is incident on the detector at the desired spot size without passing through any intervening optical elements. This approach, in combination with an off-axis illumination design, such as the embodiment depicted in FIG. 4, is advantageous because it eliminates the likelihood that particles settle on optical surfaces in the collection path and contaminate the optical signal received on the detector.

As depicted in FIG. 4, illumination 102 is provided to the surface of wafer 113 at an oblique angle by the illumination subsystem. In some embodiments, the oblique angle of incidence is selected to be an angle of incidence near normal incidence, e.g., one degree or more, up to ten degrees from normal incidence.

In another aspect, a surface topography measurement system includes a computing system configured to generate a map of wafer locations and corresponding wafer tilt in two dimensions.

As depicted in FIG. 4, computing system 140 includes a clock (not shown) that triggers the simultaneous acquisition of signals indicative of wafer location, signals indicative of beam pointing orientation, and signals indicative of the position of incidence of the reflected beam on the active surface of the detector. This signal information is processed by computing system 140 to generate a map of wafer tilt at specific locations on the wafer.

In the embodiment depicted in FIG. 4, computing system 140 acquires signals 131 from detector 120 indicative of the position of incidence of reflected beam 118 on the active surface 119 of detector 120 at a measurement instance triggered by computing system 140. In one example, computing system 140 determines the surface tilt associated with the measurement instance in two dimensions as illustrated in Equations (1)-(6). In some embodiments, signals 131 are quadrature signals A, B, C, and D as illustrated in Equations (1) and (2). In some embodiments, signals 131 are position signals ΔX and ΔY. In these embodiments, detector 120 includes signal processing capability in addition to signal acquisition.

In addition, computing system 140 acquires signals 136 indicative of the position of wafer 113 with respect to surface topography measurement subsystem 150. Wafer positioning system 125 includes sensors (not shown) to track the location of wafer 113 with respect to a machine frame to which surface topography measurement subsystem 150 is attached. In some embodiments, wafer positioning system 125 includes a rotary encoder and a linear encoder to track the rotational position of wafer 113 and the linear position in the translational direction, e.g., the X-direction depicted in FIG. 2. Wafer positioning system 125 also includes calibration sensors (not shown) to reference the encoder measurements to wafer coordinates with respect to the machine frame. In this manner, signals 136 generated by the wafer position sensors of wafer positioning system 125 indicate the position of wafer 113 with respect to the machine frame in terms of wafer coordinates.

In addition, computing system 140 acquires signals 135 communicated to beam steering device 106 indicative of the beam pointing orientation of illumination beam 102. In some embodiments, beam steering device 106 includes high speed drive electronics, e.g., a radio frequency amplifier, that generate the drive signals communicated to the actuator(s) of beam steering device 106 in response to command signals 135. In one example, the high speed drive electronics generate sinusoidal drive signals in response to sinusoidal command signals 135 communicated from computing system 140. In some embodiments, the high speed drive electronics respond to command signals 135 generated by a radio frequency synthesizer integrated with computing system 140. In general, the lag introduced by the high speed electronics and the actuator(s) is very small. In these embodiments, the signal value of the command signal 135 at the measurement instance is indicative of the beam pointing orientation of illumination beam 102. As such, at a particular measurement instance, computing system 140 acquires the signal value of command signal 135 and estimates the beam pointing orientation of illumination beam 102 directly from the acquired value.

In a further aspect, for each measurement instance, computing system determines the location of incidence of illumination beam 102 on the surface of wafer 113 in terms of wafer coordinates based on the wafer position determined from signals 136 and the beam pointing orientation determined from signals 135, and associates the surface tilt determined from signals 131 with the location of incidence. A map of wafer tilt 132 expressed in terms of wafer locations is generated by aggregating the results of many measurement instances generated over the surface of wafer 113. By periodically acquiring signals 131, 136, and 135 while illumination beam 102 is scanned over wafer 113, which itself is being continuously moved by wafer positioning system 125, a map of surface tilt 132 expressed in terms of wafer coordinates is generated. The timing of signal acquisition is coordinated with the scan rate of illumination beam 102 and the motion trajectory of wafer 113 to determine surface tilt at a large number of acquisition locations, i.e., pixels, spaced apart at regular spatial intervals across the wafer surface.

In one example, a grid of 1500 by 1500 pixels may be employed across the wafer surface of a 300 millimeter wafer, such that each pixel is separated from adjacent pixels by 200 micrometers in the X and Y directions. In some embodiments, illumination beam 102 generates a measurement spot size of 150 micrometers, or smaller. In general, pixel spacing be any desired spacing ranging from very small, e.g., 10 micrometers, or less, to very large, e.g., 1 millimeter, or more.

In a further aspect, computing system 140 is configured to generate a high resolution surface height map based on the measured surface tilt map. The high resolution surface height map has high resolution in the direction normal to the surface of the wafer, e.g., sub-nanometer height resolution, with a high spatial resolution in the in-plane directions, e.g., the X-Y directions. In some examples, computing system 140 generates a surface height map with in-plane spatial resolution of 200 micrometers, or less.

In some examples, computing system 140 employs an algorithm described in “A Line-Integration Based Method for Depth Recovery from Surface Normals” by Zhongquan Wu and Lingxiao Li, published in Computer Vision, Graphics, and Image Processing, volume 43, pages 53-66 (1988), the entire disclosure of which is incorporated herein by reference. As illustrated by Equation (7), the algorithm determines the height z(i, j) of a pixel having the indices i and j by trapezoidal approximation of line integrals, where p and q are the surface slopes in the X- and Y-directions, respectively, i₀ and j₀ refer to a reference point having a reference height, z₀, and Δx and Δy are spatial intervals between pixels in the X and Y directions, respectively.

$$z ( i , j ) = {z}_{0} + \frac{1}{2} ( \frac{q ( {i}_{0} , {j}_{0} ) + q ( {i}_{0} , j )}{2} + {\sum }_{k = {j}_{0} + 1}^{j - 1} q ( {i}_{0} , k ) ) Δ y + \frac{1}{2} ( \frac{p ( {i}_{0} , {j}_{0} ) + p ( i , j )}{2} + {\sum }_{k = {i}_{0} + 1}^{i - 1} p ( k , {j}_{0} ) ) Δ x + \frac{1}{2} ( \frac{p ( {i}_{0} , {j}_{0} ) + p ( i , {j}_{0} )}{2} + {\sum }_{k = {i}_{0} + 1}^{i - 1} p ( k , {j}_{0} ) ) Δ x + \frac{1}{2} ( \frac{q ( i , {j}_{0} ) + q ( i , j )}{2} + {\sum }_{k = {j}_{0} + 1}^{j - 1} q ( i , k ) ) Δ y \qquad ( 7 )$$

In some embodiments, a map of reference heights is imported onto computing system 140 from another measurement source, e.g., another measurement tool. However, in some embodiments, a map of reference heights, e.g., z₀ illustrated in Equation (7), is generated from trusted height measurements acquired by an absolute height sensor integrated with a surface topography measurement system.

In the embodiment depicted in FIGS. 1 and 4, a capacitive probe 116 is attached to the machine frame facing the surface of wafer 113. Capacitive probe 116 generates a signal 133 indicative of the distance between the capacitive probe and the surface of wafer 113. Computing system 140 determines a difference between the measured distance 133 and a zero height offset distance to determine the measured height at each measured location on the wafer. The zero height offset is a distance between the capacitive probe 116 and the measured surface where the zero height of the wafer is known or assumed. In one example, the zero height offset is the average measured distance at all measured locations on the wafer. In some other examples, the zero height offset is the distance between the capacitive probe 116 and the measured surface at a predetermined location on the wafer. In this manner, computing system 140 generates a map of the height of the surface of wafer 113 at many locations on the wafer surface.

The effective measurement area 115 of a capacitive probe, such as capacitive probe 116 is relatively large, e.g., 2 millimeter diameter measurement spot size, compared to the measurement spot size of a surface topology measurement subsystem as described herein. As a result, the in-plane spatial resolution of a height map generated by capacitive probe 116 is much lower, e.g., one order of magnitude lower, than the in-plane spatial resolution of the tilt map 132. However, by referencing the height measurements provided by capacitive probe 116 in the integration of the tilt map 132, computing system 140 generates a height map 137 having high in-plane spatial resolution, e.g., same in-plane spatial resolution as tilt map 132, that is consistent with the low resolution height map generated based on the capacitive probe measurements.

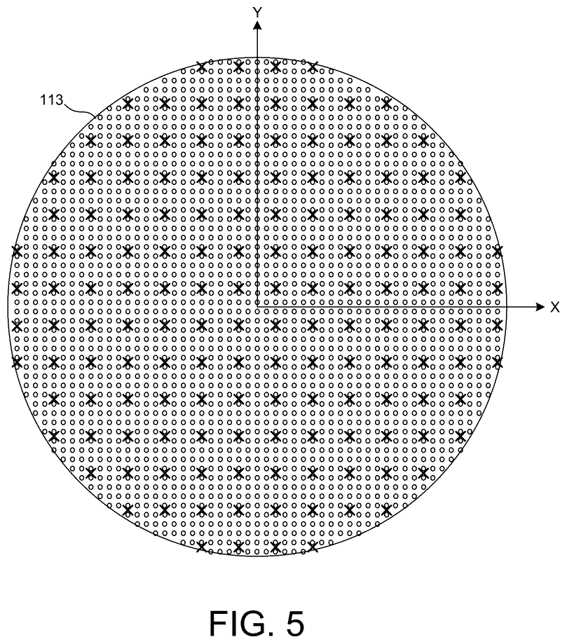

FIG. 5 is a diagram illustrative of the map locations of an exemplary low resolution height map generated by an absolute sensor such as capacitive probe 116 and an exemplary high resolution height map generated by integration of a tilt map generated by a surface topography measurement subsystem. The wafer locations of a low resolution height map are marked by an “X”, and the wafer locations of a higher resolution height map derived from integration of a tilt map are by a “O”. FIG. 5 is not drawn to actual scale, as the actual number of wafer locations in a typical measurement application are much greater and would not be visible in a scale drawing. FIG. 5 is provided to illustrate the in-plane spatial resolutions of the low and high resolution height maps in relative terms, in one example.

It is known that in some examples, wafer surface reflectivity depends on the polarization of the illumination beam. To eliminate measurement bias across the surface of a wafer, in some embodiments, beam polarization is changed on a time scale much shorter than a measurement interval.

In some embodiments, random polarization may be employed. In some of these embodiments, a non-polarizing laser based illumination source is employed with a mirror based beam steering device to ensure that the polarization of the illumination beam is randomly changing at a high rate relative to the sample time associated with each measurement signal acquisition from the detector. This ensures that any polarization dependent element of wafer reflectivity is averaged out over the time scale of signal acquisition at each measurement instance.

In some embodiments, a quarter wave plate is located in the illumination optical path after a linear polarizer to achieve circular polarization of illumination beam 102 at incidence with the surface under measurement. In these embodiments, the polarization of the illumination beam is changing in a well-defined manner, but at a high rate relative to the sample time associated with each measurement signal acquisition from the detector. This ensures that any polarization dependent element of wafer reflectivity is averaged out over the time scale of signal acquisition at each measurement instance.

Circular polarization of the illumination beam of a surface topography measurement subsystem may be advantageous for subsystems that employ an AOD for beam steering. In these embodiments, linear polarization must be implemented before entry into the AOD. Since the illumination light must be linear polarized, the addition of a quarter wave plate to circularly polarize the illumination beam before incidence with the surface under measurement enables a reduction of polarization dependent reflectivity effects with little cost in system complexity and loss of beam power. In the embodiments depicted in FIGS. 1 and 4, a quarter wave plate 109 is located in the illumination optical path after linear polarizers 105 and 108. In this manner, illumination beam 102 is circularly polarized at incidence with the surface of wafer 113.

Although the embodiments depicted in FIGS. 1 and 4 employ circular polarization, in general, it is optional. For some samples, the dependence of surface reflectivity on polarization is negligible. In these examples, quarter waver plate 109 may be omitted without significant loss of measurement accuracy.

In general, any suitable illumination optical elements may employed to provide illumination light 102 onto wafer 113 over a desired measurement spot size. In some embodiments, one or more beam shaping elements are included in the illumination optical path (i.e., the optical path between illumination source 101 and wafer 113) to form a desired beam profile. Exemplary beam profiles include a Gaussian beam shape, a ring beam shape, a flat-top beam shape, etc. In some examples, measurement spot sizes include measurement spots characterized by a dimension of longest extent across the measurement spot having a length as small as one micrometer to as large as five hundred micrometers. In preferred embodiments, measurement spot sizes employed in the characterization of bare wafers include measurement spots characterized by a dimension of longest extent across the measurement spot having a length as small as 10 micrometers to as large as 250 micrometers.

In a further aspect, a surface topology measurement system is configured to identify regions of a substrate having variation in surface height, surface tilt, or both, that exceed predetermined threshold values. In some embodiments, computing system 140 is configured to identify regions of wafer 113 having changes in surface height, surface slope, or both, over a given lateral distance along the surface that exceed predetermined threshold values. These regions are highlighted as possible defect regions that require subsequent cleaning, rework, disposal, etc.

The surface topology measurement systems described herein employ an illumination beam incident of the surface of a substrate at a near-normal incidence angle, e.g., 10 degrees, or less. However, it is not essential for the practice of the present invention, to employ near-normal incidence angles. For incidence angles far from normal, there may be some degradation in the sensitivity of the detection device that senses the change in location of the reflected beam, particularly along the direction that is normal to the plane of incidence. Additionally, the equations relating the change in reflected beam location to the underlying changes in surface slope may become more complex to account for the effect of the larger incidence angles. However, in other aspects, the present invention is equally applicable to an apparatus providing larger incidence angles.

In general, computing system 140 is configured to measure surface topology of substrates. The computing system 140 may include any appropriate processor(s) known in the art. In addition, the computing system 140 may be configured to use any appropriate measurement algorithm or method known in the art.

In addition, measurement systems 100 and 200 may include peripheral devices useful to accept inputs from an operator (e.g., keyboard, mouse, touchscreen, etc.) and display outputs to the operator (e.g., display monitor). For example, input commands from an operator may be used by computing system 140 to adjust the sampling locations on a wafer. The resulting sampling locations may be graphically presented to an operator on a display monitor.

Measurement systems 100 and 200 include a processor 141 and an amount of computer readable memory 142. Processor 141 and memory 142 may communicate over bus 143. Memory 142 includes an amount of memory 144 that stores a program code that, when executed by processor 141, causes processor 141 to execute the defect detection and classification functionality described herein.

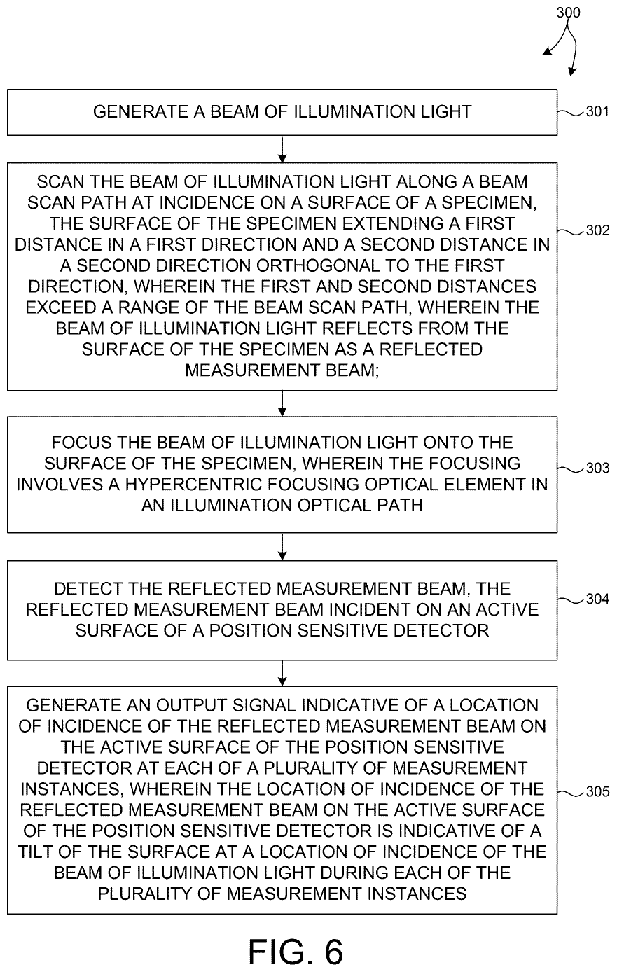

FIG. 6 illustrates a flowchart of an exemplary method 300 useful for characterizing surface topology. In some non-limiting examples, measurement systems 100 and 200 described with reference to FIGS. 1 and 4, respectively, are configured to implement method 300. However, in general, the implementation of method 300 is not limited by the specific embodiments described herein.

In block 301, a beam of illumination light is generated by an illumination source.

In block 302, the beam of illumination light is scanned along a beam scan path at incidence on a surface of a specimen. The surface of the specimen extends a first distance in a first direction and a second distance in a second direction orthogonal to the first direction. The first and second distances exceed a range of the beam scan path. The beam of illumination light reflects from the surface of the specimen as a reflected measurement beam.

In block 303, the beam of illumination light is focused onto the surface of the specimen. The focusing involves a hypercentric focusing optical element in an illumination optical path of the illumination beam.

In block 304, the reflected measurement beam is detected by a position sensitive detected. The reflected measurement beam is incident on an active surface of the position sensitive detector.

In block 305, an output signal indicative of a location of incidence of the reflected measurement beam on the active surface of the position sensitive detector is generated at each of a plurality of measurement instances. The location of incidence of the reflected measurement beam on the active surface of the position sensitive detector is indicative of a tilt of the surface at a location of incidence of the beam of illumination light during each of the plurality of measurement instances.

Various embodiments are described herein for a measurement system or tool that may be used for inspecting a specimen. The term “specimen” is used herein to refer to a wafer, a reticle, or any other sample that may be inspected for defects, features, or other information (e.g., an amount of haze or film properties) known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as quartz. A reticle may be disposed above a resist-covered wafer during an exposure step of a lithography process such that the pattern on the reticle may be transferred to the resist.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A surface topography measurement system comprising:
an illumination source configured to generate a beam of illumination light;
a beam steering device in an illumination optical path of the beam of illumination light from the illumination source to a surface of a specimen under measurement, the beam steering device configured to scan the beam of illumination light along a beam scan path at incidence on the surface of the specimen, the surface of the specimen extending a first distance in a first direction and a second distance in a second direction orthogonal to the first direction, wherein the first and second distances exceed a range of the beam scan path, wherein the beam of illumination light reflects from the surface of the specimen as a reflected measurement beam;
a hypercentric focusing optical element in the illumination optical path between the beam steering device and the surface of the specimen; and
a position sensitive detector in an optical path of the reflected measurement beam, the reflected measurement beam incident on an active surface of the position sensitive detector, wherein the position sensitive detector generates an output signal indicative of a location of incidence of the reflected measurement beam on the active surface of the position sensitive detector at each of a plurality of measurement instances, wherein the location of incidence of the reflected measurement beam on the active surface of the position sensitive detector is indicative of a tilt of the surface at a location of incidence of the beam of illumination light during each of the plurality of measurement instances.

2. The surface topography measurement system of claim 1, further comprising:
a specimen positioning system, comprising:
a plurality of actuators configured to locate the surface of the specimen under measurement such that the beam of illumination light is incident on the surface of the specimen under measurement at any desired location on the surface, and wherein the specimen positioning system locates the surface of the specimen under measurement at a plurality of different locations corresponding to the plurality of measurement instances; and
a plurality of sensors configured to generate a specimen position signal indicative of a position of the specimen at each of the plurality of measurement instances.

3. The surface topography measurement system of claim 2, further comprising:
a computing system configured to:
receive a plurality of output signals from the position sensitive detector, each of the plurality of output signals associated with a different measurement instance of the plurality of measurement instances;
receive a plurality of specimen position signals from the specimen positioning system each of the plurality of specimen position signals associated with a different measurement instance of the plurality of measurement instances;
receive a plurality of beam pointing signals, each of the beam pointing signals indicative of a beam pointing orientation associated with the beam steering device, each of the plurality of beam pointing signals associated with a different measurement instance of the plurality of measurement instances;
determine a location of incidence of the beam of illumination light on the specimen associated with each measurement instance based on the specimen position signal and the beam pointing signal associated with each measurement instance; and
determine a local surface tilt associated with each measurement instance based on the output signal from the position sensitive detector associated with each measurement instance.

4. The surface topography measurement system of claim 1, wherein there are no optical elements in the optical path of the reflected measurement beam between the specimen and the position sensitive detector.

5. The surface topography measurement system of claim 1, further comprising:
a beam splitter in the illumination optical path of the beam of illumination light from the illumination source to the surface of a specimen under measurement, wherein the beam of illumination light is normally incident on the surface of the specimen.

6. The surface topography measurement system of claim 1, wherein an angle of incidence of the beam of illumination light at the surface of the specimen is less than ten degrees from normal to the surface of the specimen.

7. The surface topography measurement system of claim 3, the computing system further configured to:
generate an interpolated local height map of the surface of the specimen under measurement based on the local surface tilt and corresponding location of incidence associated with each measurement instance and a set of trusted height measurements of the surface of the specimen under measurement at a second plurality of locations on the surface of the specimen.

8. The surface topography measurement system of claim 7, further comprising:
a capacitive probe disposed above the surface of the specimen, wherein the capacitive probe generates the set of trusted height measurements of the surface of the specimen under measurement at the second plurality of locations on the surface of the specimen.

9. The surface topography measurement system of claim 7, wherein a spatial resolution of the interpolated local height map is at least twice a spatial resolution of the set of trusted height measurements of the surface of the specimen.

10. The surface topography measurement system of claim 1, further comprising:
a first linear polarizer located in the illumination optical path after the illumination source.

11. The surface topography measurement system of claim 10, wherein the beam steering device is an acousto-optical device (AOD) located in the illumination optical path after the first linear polarizer.

12. The surface topography measurement system of claim 11, further comprising:
a cylindrical lens located in the illumination optical path after the AOD.

13. The surface topography measurement system of claim 11, further comprising:
a second linear polarizer located in the illumination optical path after the AOD.

14. The surface topography measurement system of claim 10, further comprising:
a circular polarizer located in the illumination optical path between the first linear polarizer and the specimen.

15. The surface topography measurement system of claim 1, wherein the beam of illumination light generated by the illumination source is randomly polarized.

16. A method comprising:
generating a beam of illumination light;
scanning the beam of illumination light along a beam scan path at incidence on a surface of a specimen, the surface of the specimen extending a first distance in a first direction and a second distance in a second direction orthogonal to the first direction, wherein the first and second distances exceed a range of the beam scan path, wherein the beam of illumination light reflects from the surface of the specimen as a reflected measurement beam;
focusing the beam of illumination light onto the surface of the specimen, wherein the focusing involves a hypercentric focusing optical element in an illumination optical path;
detecting the reflected measurement beam, the reflected measurement beam incident on an active surface of a position sensitive detector; and
generating an output signal indicative of a location of incidence of the reflected measurement beam on the active surface of the position sensitive detector at each of a plurality of measurement instances, wherein the location of incidence of the reflected measurement beam on the active surface of the position sensitive detector is indicative of a tilt of the surface at a location of incidence of the beam of illumination light during each of the plurality of measurement instances.

17. The method of claim 16, further comprising:
positioning the surface of the specimen at a plurality of different locations corresponding to the plurality of measurement instances; and
generating a specimen position signal indicative of a position of the specimen at each of the plurality of measurement instances.

18. The method of claim 17, further comprising:
receiving a plurality of output signals from the position sensitive detector, each of the plurality of output signals associated with a different measurement instance of the plurality of measurement instances;
receiving a plurality of specimen position signals each of the plurality of specimen position signals associated with a different measurement instance of the plurality of measurement instances;
receiving a plurality of beam pointing signals, each of the beam pointing signals indicative of a beam pointing orientation, each of the plurality of beam pointing signals associated with a different measurement instance of the plurality of measurement instances;
determining a location of incidence of the beam of illumination light on the specimen associated with each measurement instance based on the specimen position signal and the beam pointing signal associated with each measurement instance; and
determining a local surface tilt associated with each measurement instance based on the output signal from the position sensitive detector associated with each measurement instance.

19. The method of claim 18, further comprising:
generating an interpolated local height map of the surface of the specimen based on the local surface tilt and corresponding location of incidence associated with each measurement instance and a set of trusted height measurements of the surface of the specimen under measurement at a second plurality of locations on the surface of the specimen.

20. A surface topography measurement system comprising:
an illumination source configured to generate a beam of illumination light;
a beam steering device in an illumination optical path of the beam of illumination light from the illumination source to a surface of a specimen under measurement, the beam steering device configured to scan the beam of illumination light along a beam scan path at incidence on the surface of the specimen, wherein the beam of illumination light reflects from the surface of the specimen as a reflected measurement beam;
a hypercentric focusing optical element in the illumination optical path between the beam steering device and the surface of the specimen;
a position sensitive detector in an optical path of the reflected measurement beam, the reflected measurement beam incident on an active surface of the position sensitive detector, wherein the position sensitive detector generates an output signal indicative of a location of incidence of the reflected measurement beam on the active surface of the position sensitive detector at each of a plurality of measurement instances, wherein the location of incidence of the reflected measurement beam on the active surface of the position sensitive detector is indicative of a tilt of the surface at a location of incidence of the beam of illumination light during each of the plurality of measurement instances; and
a non-transitory, computer-readable medium storing instructions that, when executed by one or more processors, causes the one or more processors to:
receive a plurality of output signals from the position sensitive detector, each of the plurality of output signals associated with a different measurement instance of the plurality of measurement instances;
receive a plurality of specimen position signals indicative of a position of the specimen with respect to a machine frame of the specimen topography measurement system, each of the plurality of specimen position signals associated with a different measurement instance of the plurality of measurement instances;
receive a plurality of beam pointing signals, each of the beam pointing signals indicative of a beam pointing orientation associated with the beam steering device, each of the plurality of beam pointing signals associated with a different measurement instance of the plurality of measurement instances;
determine a location of incidence of the beam of illumination light on the specimen associated with each measurement instance based on the specimen position signal and the beam pointing signal associated with each measurement instance; and
determine a local surface tilt associated with each measurement instance based on the output signal from the position sensitive detector associated with each measurement instance.
